(19) United States
(12) Patent Application Publication
(10) Pub. No.: US 2005/0011313 A1
(43) Pub. Date: Jan. 20, 2005

(54) Compact hydraulic torque wrench reaction arm

(75) Inventor: Steven E. Spirer, Washington Township, NJ (US)

Correspondence Address: WEINGRAM & ASSOCIATES P.C., P.O. BOX 927, MAYWOOD, NJ, 07607, US

(73) Assignee: NORWOLF TOOL WORKS

(21) Appl. No.: 10/842,644

(22) Filed: May 10, 2004

Related U.S. Application Data
(63) Continuation-in-part of application No. 10/175,524, filed on Jun. 19, 2002, now abandoned.
(60) Provisional application No. 60/299,534, filed on Jun. 20, 2001.

(51) Int. Cl. B25B 13/46

(52) U.S. Cl. 81/57.39

(57) ABSTRACT

A compact hydraulic torque wrench which has an efficient design enabling it to be relatively small in size. The arrangement of the return spring for the hydraulic cylinder provides increased strength and reduces the size of the unit. The device is constructed to enable the drive arm to go through the entire travel without change in alignment. Additionally, the device includes a braking system for the reaction arm to ensure that a ratcheting effect occurs and that the proper return of the hydraulic piston can be accomplished by means of a return spring without the necessity for a hydraulic return of the piston.

### CROSS REFERENCE TO RELATED APPLICATIONS

This application is based upon and claims the benefit of application Ser. No. 10/175,524 filed Jun. 19, 2002, now abandoned, which in turn is based upon and claims the benefit of provisional application No. 60/299,534 filed Jun. 20, 2001, incorporated herein by reference.

### FIELD OF THE INVENTION

The present application pertains to power tools and particularly to hydraulic torque wrenches.

### BACKGROUND OF THE INVENTION

Hydraulic torque wrenches are often large and awkward to use. They are difficult to reach into small places, they are heavy, and they are relatively complex devices.

Additionally, the device often will hang up, and will not operate because of misalignment of the piston due to changes in the angle of the drive arm as the wrench goes through the cycle of travel.

### OBJECTS AND SUMMARY OF THE INVENTION

The present invention sets forth a compact hydraulic torque wrench which has an efficient design enabling it to be relatively small in size. The arrangement of the return spring for the hydraulic cylinder provides increased strength which reduces the size of the unit. The device is constructed in such a way to enable the drive arm go through its entire travel without change in alignment.

Additionally, the device includes a braking system for the reaction arm to ensure that a ratcheting effect occurs and that the proper return of the hydraulic piston can be accomplished by means of a return spring without the necessity for a hydraulic return of the piston.

Accordingly, it is an object of the present invention to provide a compact hydraulic torque wrench in which the return spring is disposed within the piston to reduce the length and diameter required for the piston assembly.

It is another object of the present invention to provide a compact hydraulic torque wrench in which the return spring can be heavier than normal return springs because of its disposition within the piston rather than encircling the piston.

It is another object of the present invention to provide a compact hydraulic torque wrench which does not produce any side loads on the piston during the normal travel of the piston.

It is another object of the present invention to provide a compact hydraulic torque wrench in which the piston is guided throughout its entire length of travel.

It is another object of the present invention to provide a compact hydraulic torque wrench in which the pitch angle of the drive arm never changes as the arm moves along its entire path of travel.

It is another object of the present invention to provide a compact hydraulic torque wrench which can have access to the hydraulic cylinder from either the top or the front.

Another object of the present invention to provide a compact hydraulic torque wrench which has provisions for a reaction arm to fit within the housing to provide a wide flexibility of operation for the wrench.

It is still another object of the present invention is to provide a compact hydraulic torque wrench which has a brake system from which is enabled the braking of the hydraulic arm to overcome the ratchet action in the drive arm.

Other objects of the present invention are to provide a compact hydraulic torque wrench is relatively small in size, relatively light, which has relatively few moving parts, which is relatively simple to manufacture, which is relatively durable, which is relatively inexpensive to produce and which is relatively flexible and easy to use.

### BRIEF DESCRIPTION OF THE DRAWINGS

For a more complete understanding of the present invention reference may be had to the following drawing taken in connection with the description of the preferred embodiments, of which:

FIG. 1 is a side view drawing of a compact torque wrench of the current invention.

FIG. 2 is a rear view drawing of the torque wrench shown in FIG. 1.

FIG. 3 is a top view drawing of the torque wrench shown in FIG. 1 showing the housing only.

FIG. 4 is an exploded view of the components of a compact torque wrench built in accordance with the teachings of the current invention but of slightly different embodiment with respect to the mounting of the closure plate on the back of the housing.

FIG. 5 is a perspective view of the housing from the rear showing the arms of the housing and the holes for the output drive.

FIG. 6 is a rear perspective view of the housing showing the cylinder and the step in the cylinder for coaction with the piston to limit the travel of the piston.

FIG. 7 is a view showing the components of the piston and return spring, the drive arm and the output drive and the braking mechanism for the output drive mounted to the housing.

FIG. 8 is a perspective view showing the piston, the piston arms, the spring guide cylinder within the piston, and the seal at the front of the piston.

FIG. 9 is a view of the piston showing the return spring in the spring guide cylinder of the piston and showing the drive arm mounted within the arms of the piston, with the output drive mounted in the drive arm.

FIG. 10 is a perspective view of the drive arm showing the elongated slots for mounting to the piston and showing the output drive ratchet in place and also showing the passage in the drive arm for a set screw in the output ratchet gear socket.

FIG. 11 shows an access hole at the bottom of the output arm which is used to gain access to the set screw mounted in the output ratchet gear so that a wrench rod can be placed into the socket to make a positive wrench as well as a socket.

FIG. 12 shows the orientation of the brake assembly with the output drive gear.

FIG. 13 is a perspective view from the lower rear of the hydraulic torque wrench of the present invention with the drive arm positioned on the right.

FIG. 14 is an assembly view showing the components of a further embodiment of the hydraulic torque wrench of the invention.

FIG. 15A is a front view of the drive arm or drive place shown in FIG. 14.

FIG. 15B is a right elevational view of the drive arm or drive plate shown in FIG. 15A.

FIG. 16A is a front view of the piston shown in FIG. 14.

FIG. 16B is a view of the piston shown in FIG. 14 from the left side.

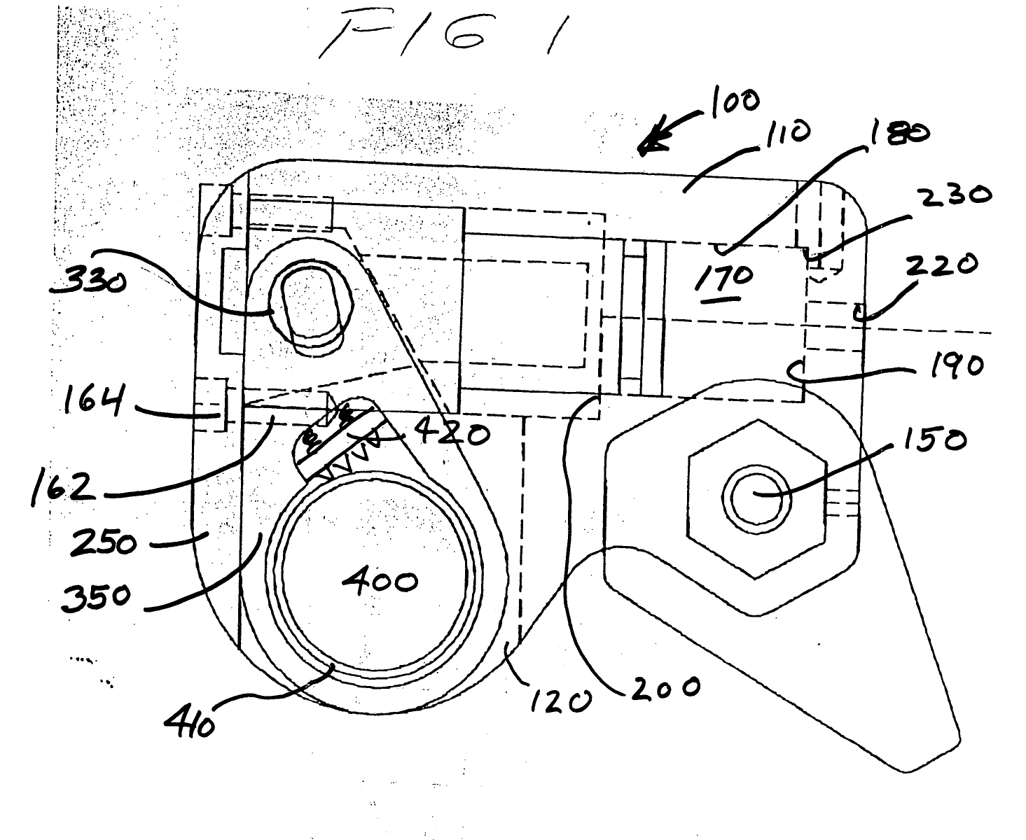

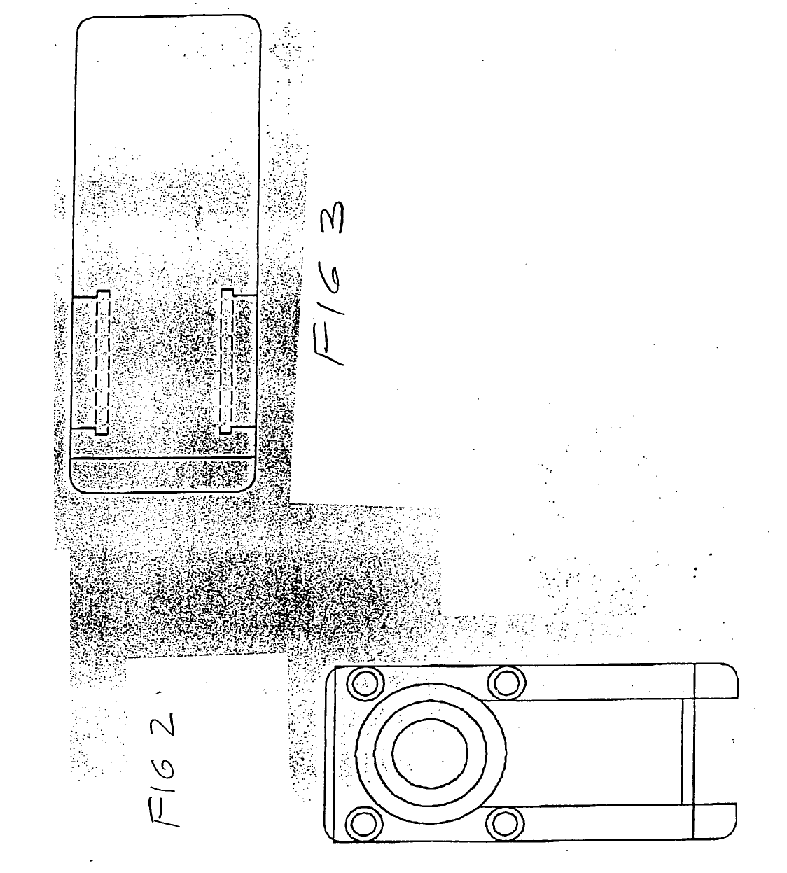

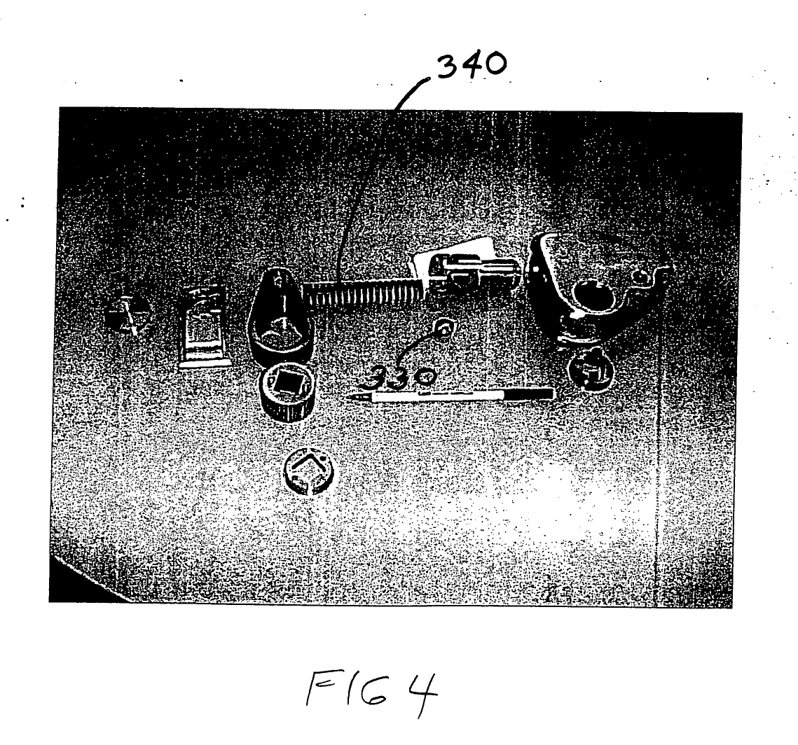

### DETAILED DESCRIPTION OF THE PREFERRED EMBODIMENTS

Glossary of Terms

a) 100 hydraulic torque wrench general
b) 110 housing
   i) 115 front end
      120 side arms
      130 aperture for the output drive
      140 lip for mounting the clutch system
      150 aperture for reaction arm
      160 keyway for mounting back wall of housing
      162 threaded passages in side arms as alternative
      164 stress securing back wall to housing
   ii) 170 cylinder
      180 cylindrical wall
      190 forward end
      200 shoulder
      210 ramp at end of piston
   iii) Inlets
      220 front inlet
      230 top inlet
      240 hydraulic connection
   iv) 250 back wall of housing
      262 closure or pressure plate for back wall of housing
      265 recess which forms a seat for return spring 340
c) 260 piston
   i) 270 shaft
      280 front end or top surface
      290 seal
      300 spring guide bore within the piston
   ii) 310 arms
   iii) 320 apertures for piston pins
      210 piston
   iv) 330 piston pins
d) 340 return spring
e) 350 output plate
   i) 360 arms of output plate
      362 elongated slots
   ii) 370 circular opening for output drive gear
   iii) 380 opening for pawl
   iv) 390 access opening for set screw in output drive
f) 400 output drive
   i) 410 ratchet gear
   ii) 420 pawl in output arm
   iii) 430 threaded passages for cover screws
   iv) 440 cover for ratchet gear
      450 brake assembly for ratchet gear
      452 0 ring in cover for ratchet
      454 screw in cover for squeezing O ring against lip 140
   v) 460 set screw to hold output socket or output wrench
   vi) 470 output socket
   vii) 480 output wrench (alternate)
g) 490 reaction arm
h) 500 foot for reaction arm

With reference to the drawings, we can see that the torque wrench has a housing with side arms and passages for mounting the output drive gear. The housing has a cylinder inside it which is used for guiding and coacting with the piston and the cylinder walls have a step in them which coacts with a step in the piston to limit the travel forward of the piston. There are multiple inlets at the front of the housing, one from the front and one from the top so that hydraulic connections can be made either from the top or the front to increase the flexibility of the device by allowing it to be used in various locations and attitudes which would not normally be possible because of the hydraulic input lines.

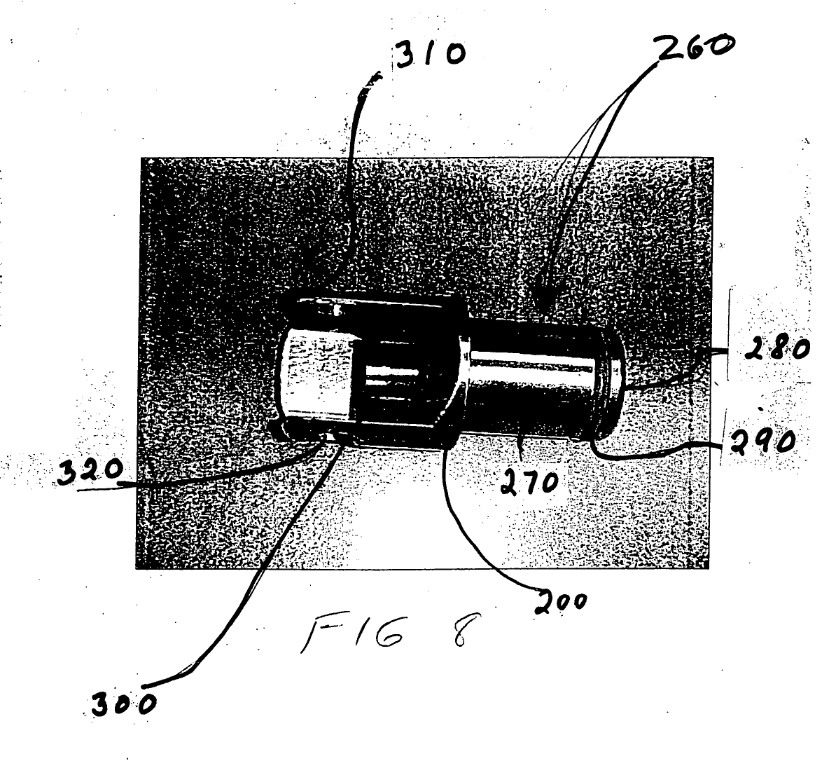

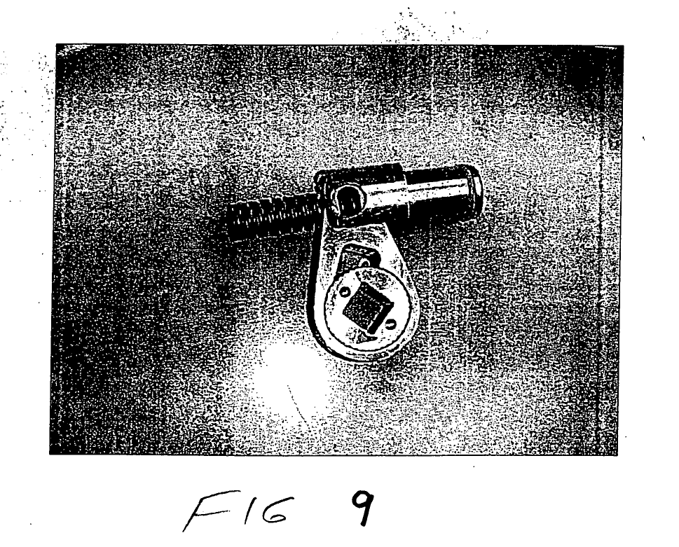

The piston has a conventional top surface and a shaft with a seal mounted on it. The piston shaft which then opens up into two arms as can be seen in FIG. 8. It also shows that there is a spring guide shaft cylinder within the piston shaft to accommodate the return spring. This enables the return spring to be thicker, and stronger and occupy much less room then the usual return spring for a piston. Normally the return spring would have to be wound around the outside of the piston shaft where it would have to have a larger area for dead ending the piston and would take up substantially more room. Here, the spring fits inside the piston spring guide cylinder and the other end acts against the back wall of the housing. The arrangement of the spring in the piston shaft with the output arm is shown best in FIG. 9.

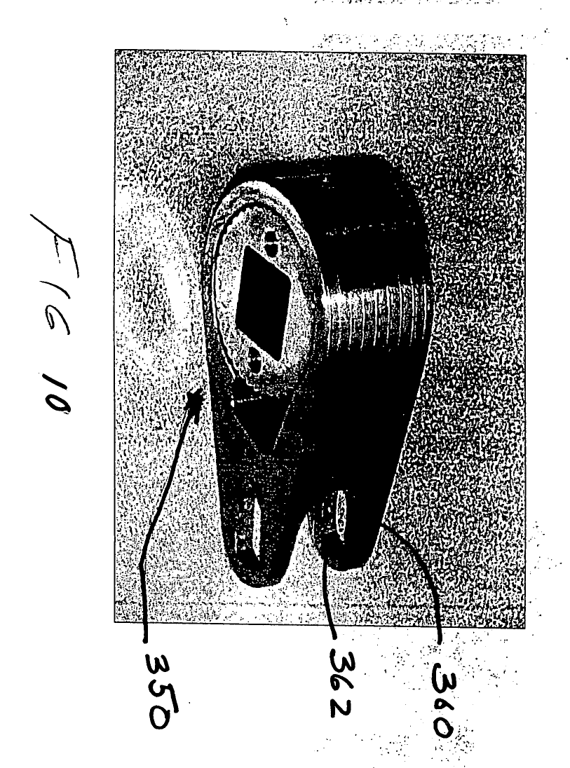

Note that the output arm as shown in FIG. 10 has elongated slots at the upper end for joining to the piston so that movement of the output arm as the piston moves backward in its travel will not produce a force tending to cock the piston. Instead the arm itself will be able to slide relative to the piston, so the piston will always be working without interfering with the cylinder wall or housing.

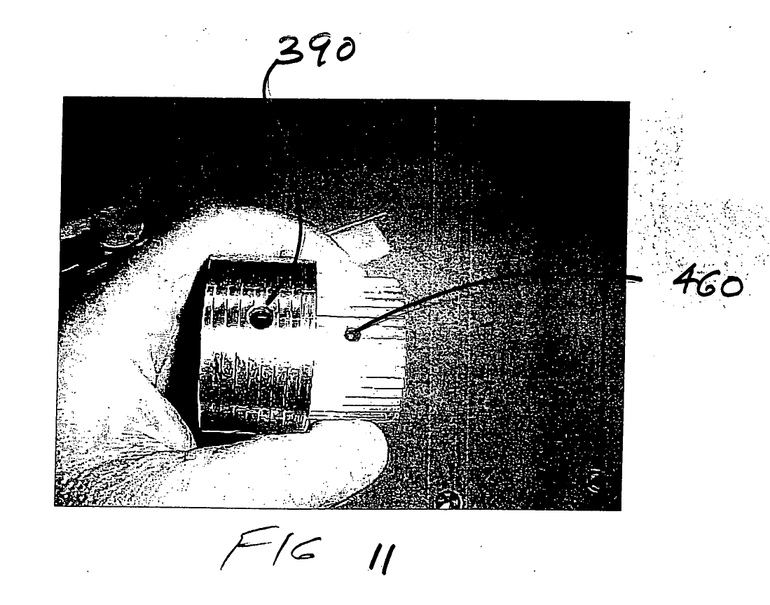

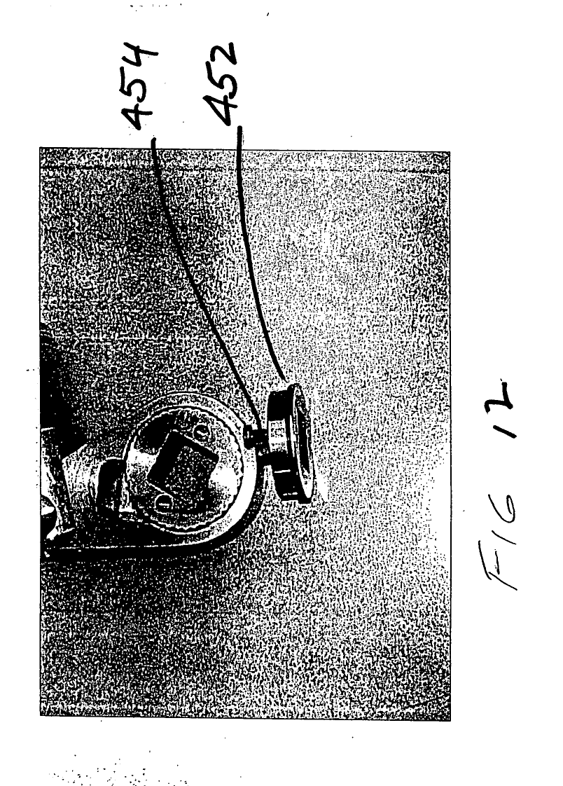

The output drive arm or output plate as shown in FIG. 9 and 12 is provided with an output drive which has a ratchet gear with a square socket opening or which can have a square piece of stock put into the socket and held by a set screw shown in FIGS. 11 and 13. Access to the set screw is through the passage hole in the bottom of the output arm.

When the hydraulic fluid is placed into the assembled hydraulic torque wrench, the piston will move back against the action of the spring. As it moves back, the change in height of the output arm will be compensated for by the slots in the top of the arm. The output drive will rotate with the action arm because the pawl will hold it stationary with respect to the output arm as the output arm rotates.

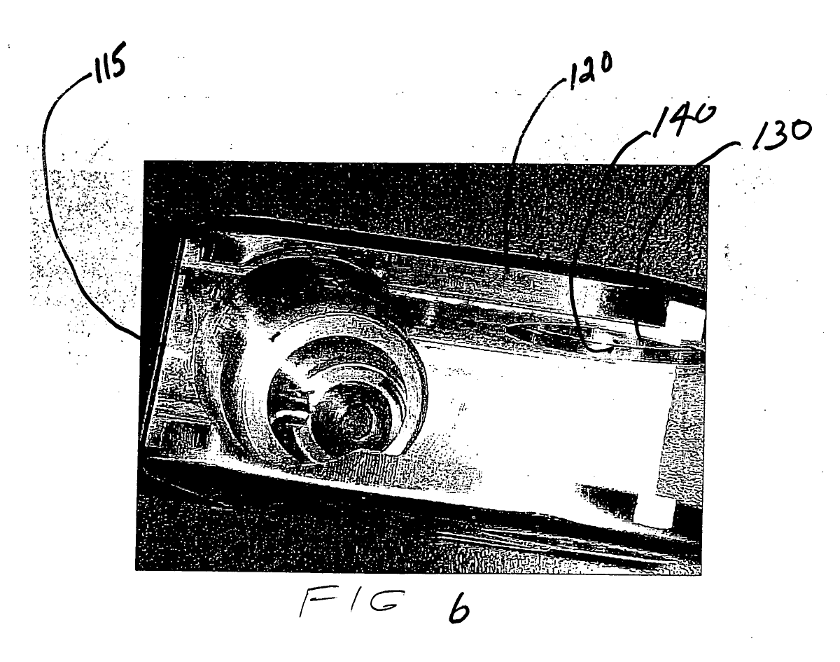

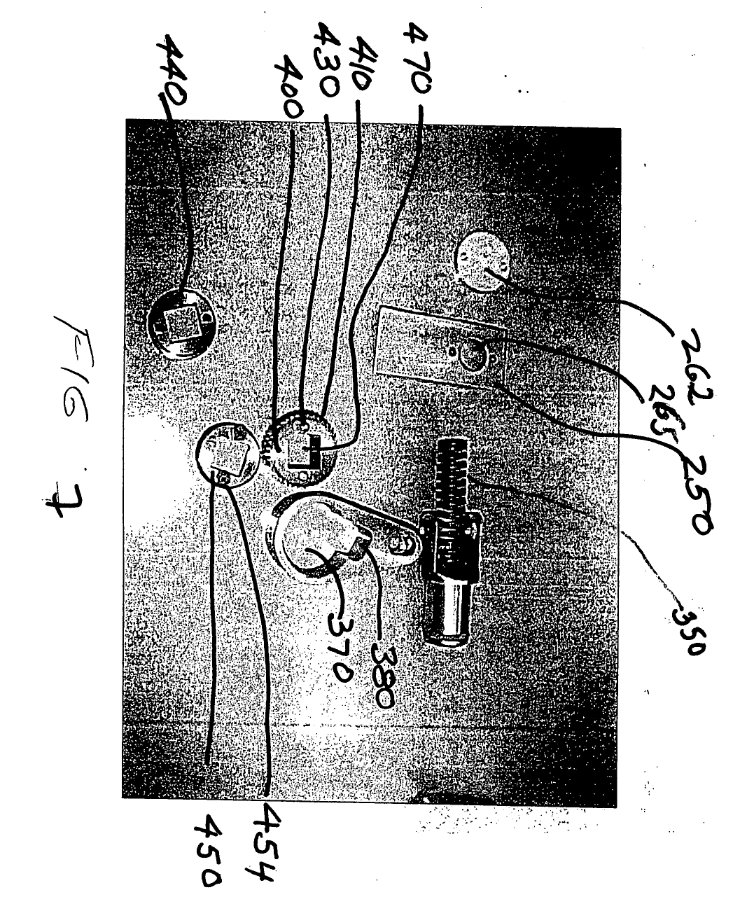

When the output arm reaches the end of its travel as determined by the ramp in the piston, the hydraulic pressure will be released and the spring will act to return the piston to its initial starting position. The pawl will allow the output ratchet gear to slide. The cover for the output gear as shown in FIG. 12 will be mounted so that the O-ring is within the housing and will coact with the lip of the aperture in the housing arm shown in FIG. 5 to act as a braking system to prevent too rapid a return of the arm. The braking force can be adjusted by means of adjusting the screws as shown in FIG. 12 which will then squeeze the O-ring appropriately against the housing as the output gear rotates.

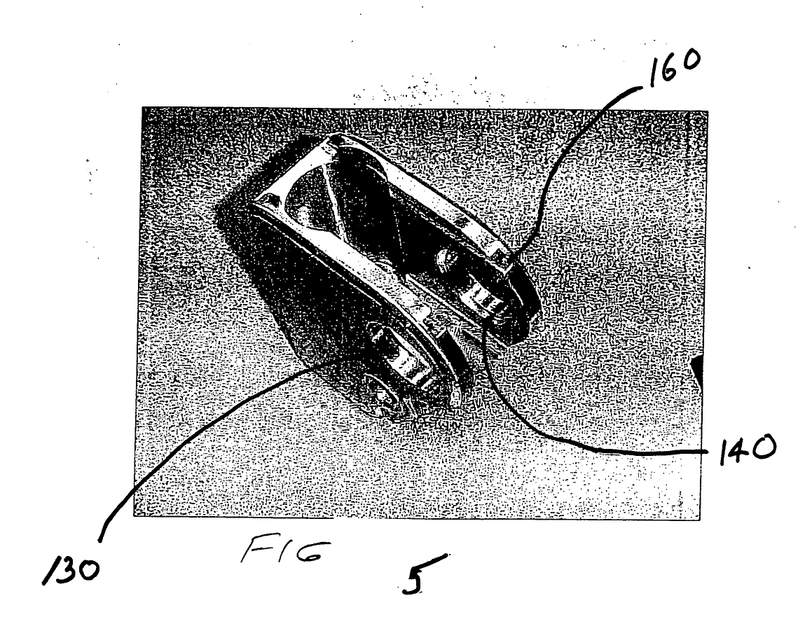

As shown in FIG. 4 there is also a cover for the other side of the output ratchet gear.

More specifically, the elements and coaction of the invention can be described as follows.

As shown in the figures, the hydraulic torque wrench of the present invention as generally indicated at 100 comprises a housing 110 having a front end 115 and having side arms 120. Apertures 130 exist in the side arms 120 for mounting of an output drive 400. The apertures 130 have a lip 140 for mounting of a clutch or braking system 450 which will be used to control the movement of the reaction arm 490. There is an aperture 150 near the front end 115 of the housing 110 which is used for mounting of a reaction arm 490.

A keyway 160 is formed in the rear of side arms 120 of the housing 110 for a back wall 250 to be slid into place to close the housing 110. Alternatively, threaded passages 162 can be formed in the rear of the side arms 120 of the housing 110 and the back wall 250. Threaded passages 162 can then be used to secure the back wall 250 to close the housing 110. A cylinder 170 is formed within the housing 110 having a cylindrical wall 180 and a forward end 190. A shoulder 200 opens the cylinder 170 to the rear of the housing 110.

Hydraulic inlets 220 on the front end 115 of the housing 110 and hydraulic inlet 230 on the top of the housing 110 provide access for hydraulic fluid to the cylinder.

The back wall 250 of the housing 110 has a closure or pressure plate 262 for the back wall 250 of the housing 110 which covers a recess 265 which forms a seat for a return spring 340. A piston 260 is located within the cylinder 170 of the housing 110. It is has a front end or top surface 280 and an external piston seal 290 along its outside surface. The piston 260 has a spring guide bore 300 machined inside the piston for positioning of a return spring 340 to act against movement of the piston 260. The piston 260 also has arms 310 which extend rearward from the forward part of the piston and are positioned so as not to interfere with the projection of the shaft 270 so that the return spring 340 can extend from within the shaft 270 to the rear of the housing 110. The arms 310 of the piston 260 have apertures 320 in which piston pins 330 will be placed to register with elongated slots 362 in arms 360 of an output plate 350 which will respond to the movement of the piston 260. The elongated slots 362 allow the piston 260 to move horizontally and to pivot the output plate 350 without placing a non-axial stress on the piston 260. In other words, the piston 260 will not be cocked as it moves rearward because of the coaction between the slots 362 in one of either the piston arms 310 or the arms of the output plate 360.

The return spring 340 extends into the shaft 270 of the piston 260 and into the recess 265 in the back wall 250 of the housing. The output plate 350 has a circular opening 370 located in the bottom of the output plate 350 and an opening 380 for mounting of a pawl 420 which will coact with a ratchet gear 410 formed on the circumference of an output drive 400 which is seated in the opening 370 of the output plate 350.

The output drive 400 has threaded passages 430 for cover screws to mount the cover 440 of the output drive 400 so that the drive will remain within the output plate 350. A brake assembly 450 for the output drive 400 is formed by an O ring 452 positioned in the cover 440 for the output drive 400 which then coacts with the lip 140 in the aperture 130 of the housing 110 so that tightening screws 454 will cause the cover 440 to squeeze the O ring 452 against the lip 140 and therefore retard the action of the output drive 400 relative to the output plate 350.

An output socket 470 can be formed in the output drive 400. Alternatively, an output wrench 480 can be inserted into the output drive 400. A reaction arm 490 is positioned within the aperture in the housing 150, and a foot 500 can be placed on the reaction arm.

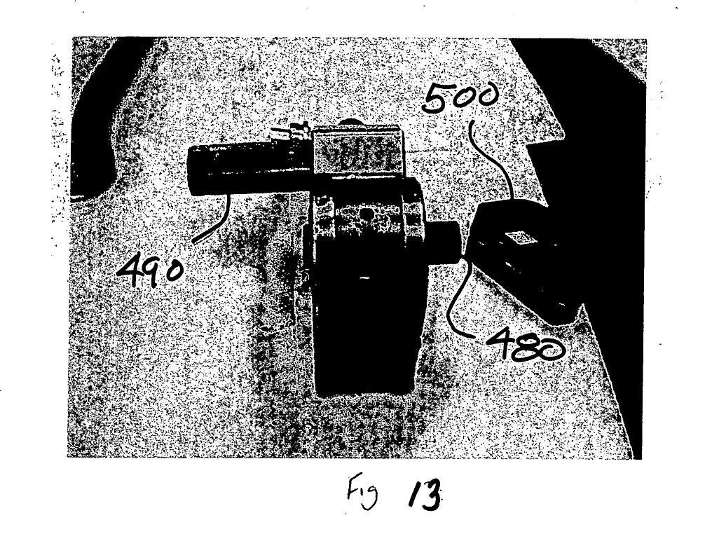

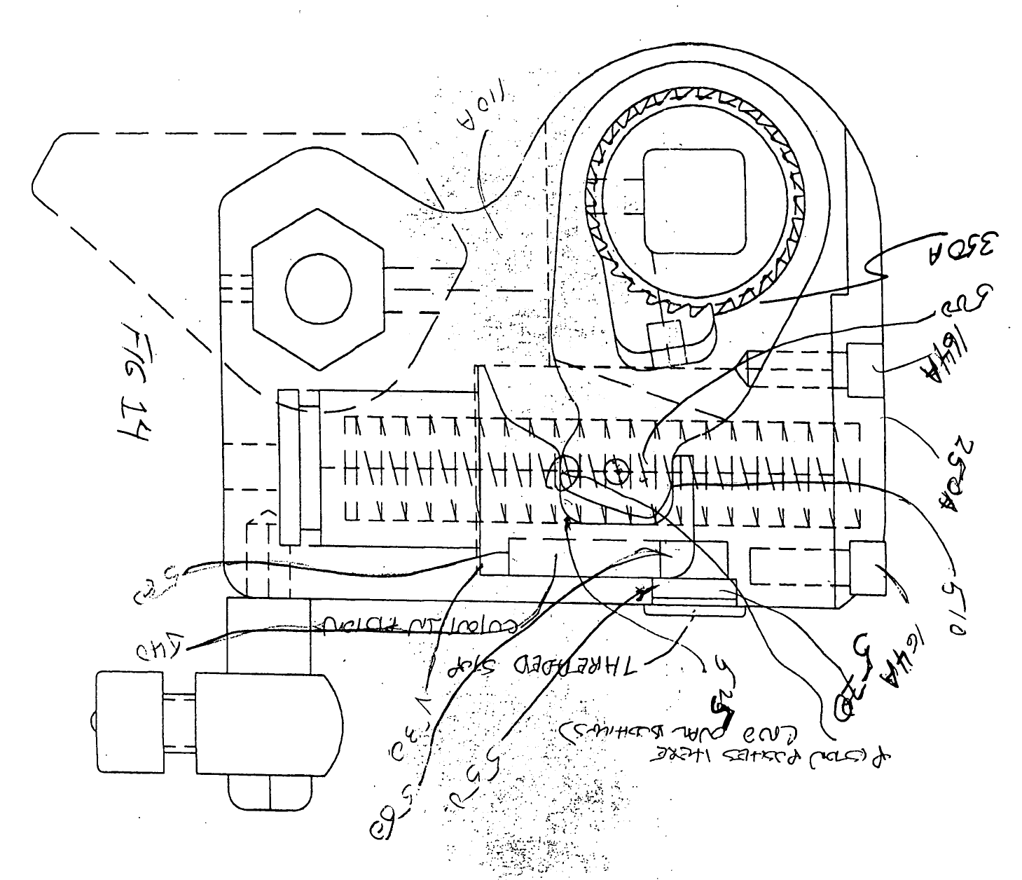

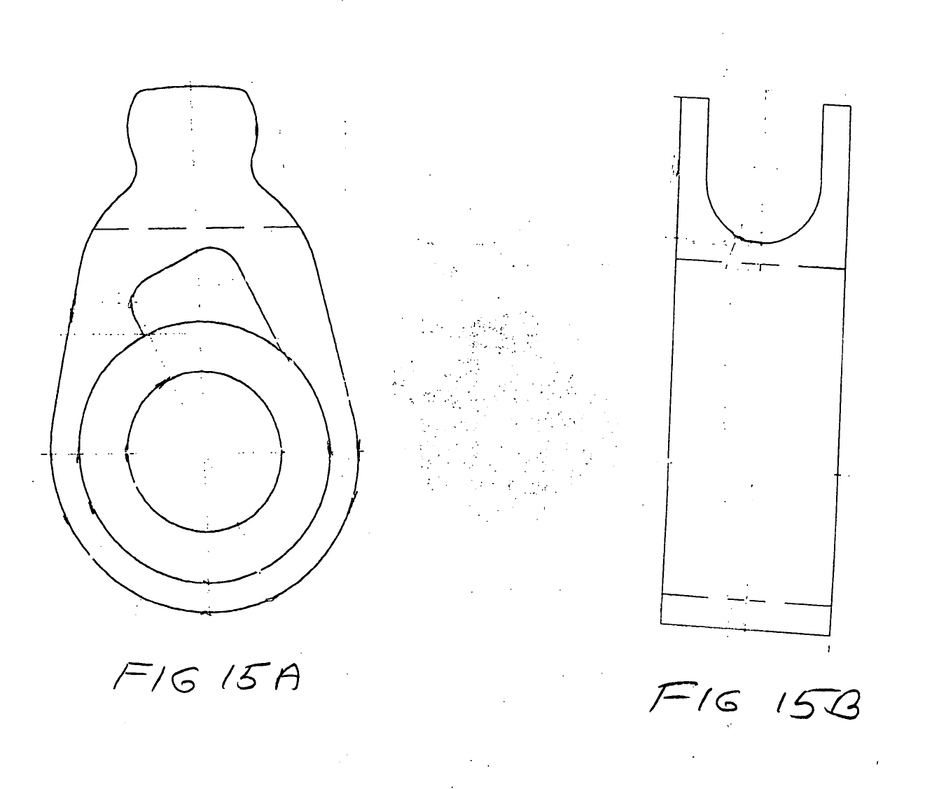

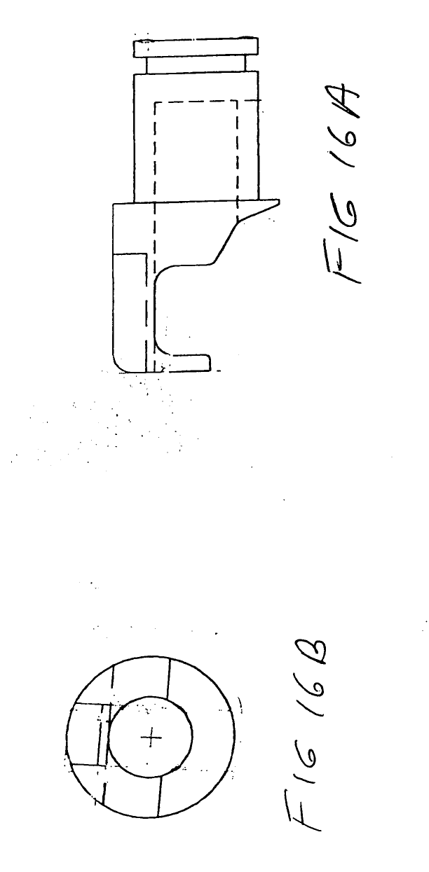

In a further embodiment, as shown in FIGS. 14 through 16, the drive plate no longer has piston pins 330 that connect to the piston 260A. Instead, the drive plate 350A has an upper end 500 having a cam-shaped surface 510 formed to coact with a cut out portion of the piston 520 having a corresponding cam shape 525 that will allow the piston to contact the cam-shaped surface 510 at the upper end of the drive plate 350A. Therefore, there is a much greater contact area between the drive plate or output plate 350A and the piston 260A than in the previous embodiment.

Additionally, the piston 260A is reconfigured to provide positive stops in coaction with the main housing 110A. The piston 260A has an enlarged shoulder 530 having a front face that bears against the shoulder 220A in the housing 110A. This provides a positive stop for the piston in the extended position of the spring 340A under low pressure.

The piston 260A has a cutout portion forming a slot 540 in which a threaded stop 550 has a lower portion 560 that extends into slot 540 and an upper threaded portion 570 that is threaded into the wall of the housing 110A. The end 580 of slot 540 is intended to coact with the engaging portion 560 of threaded stop 550 to provide a stop in the other limit of travel of the piston when the spring is most compressed.

The threaded stop 550 coacting with the piston 260A reduces the force that the spring 340A exerts on the back cover 250A of the housing 110A. This therefore greatly relieves the stress on the fastening screws 164A and on the rear of the housing 110A and the back cover 250A.

From the above, it can be seen that the invention described above is a highly compact efficient, relatively lightweight, extremely versatile, compact torque wrench. Structural features of the design provide many novel advantages.

While the invention has been described in its preferred embodiments, it is to be understood that the same is intended to be descriptive and not limiting and that changes may be made within the purview of the invention without departing from the true scope and spirit thereof.

1. A hydraulic torque wrench comprising:
a housing, comprising
a front portion,
side arms extending from the front portion,
the side arms having an aperture for an output drive,
the aperture having a lip for mounting a clutch system,
an aperture adapted to receive a reaction arm,
means for mounting a back wall to the housing,
a cylinder in the housing having
a front end,
walls, and
a shoulder opening to form the end of the cylinder,
a front inlet and a top inlet communicating with the housing cylinder adapted to receive hydraulic connections,
a back wall connected to the wings and rear of the housing,
a closure plate for the back wall of the housing,
the back wall of the housing having a recess adapted for seating of a spring,
a piston comprising
a shaft with a top surface,
a seal disposed on the outer surface of the shaft, and
a cylinder formed in the shaft of the piston adapted to receive a spring,
the piston having arms extending rearward from the cylinder portion of the piston and spaced to allow passage of a spring disposed in the shaft past the arms of the piston,
apertures disposed in the arms for mounting of piston pins,
a return spring disposed in the spring guide shaft within the piston,
an output plate disposed in the housing,
wings extending from the top of the output plate and extending to the height of the arms of the piston,
elongated slots formed in the wings of the output plate in registration with the apertures in the arms of the piston,
piston pins extending through the apertures in the arms of the piston and through the elongated slots of the wings of the output plate,
a circular opening for an output drive gear formed in the output plate, and
an opening in the output plate for mounting a pawl,
an access opening in the drive plate for securing an output drive in the circular opening of the output drive gear,
an output drive in the aperture of the circular opening of the output plate,
a ratchet gear formed on the circumference of the output drive,
a pawl mounted in the opening for the pawl in the output plate,
a cover for the ratchet gear adapted to hold the output drive in the output plate,
a brake assembly for the ratchet gear comprising
an O ring in the cover of the ratchet gear,
and screw means threadably connected to the cover of the ratchet gear and extending into threaded passages in the output drive to enable tightening of the cover against the O ring and the lip of the side arms of the housing, and
hydraulic inlets in the cylinder of the housing to allow pressurized hydraulic fluid into the cylinder,
the hydraulic fluid to act upon the end of the piston to force the piston towards the rear of the housing against the action of the return spring, the rearward movement of the piston will then cause the piston pins to pivot the output plate connected to the piston, with the elongated slots in the output plate allowing the piston to move rearward along the axis of the piston and cause the output plate to rotate as the piston moves rearward until the end of the output plate coacts with the ramp of the piston to or can no longer overcome the force of the spring, the output plate connected to the output drive by means of the ratchet gear and pawl disposed in the output plate, and rotated with the rearward movement of the output plate, and upon relaxing of the hydraulic fluid will allow the spring to act against the rear wall of the housing and the front end of the spring guide shaft in the piston to urge the piston forward.

2. A hydraulic torque wrench comprising:
a housing, comprising
a front portion,
side arms extending from the front portion,
the side arms having an aperture for an output drive,
the aperture having a lip for mounting a clutch system,
an aperture adapted to receive a reaction arm,
means for mounting a back wall to the housing,
a cylinder in the housing having
a front end,
walls, and
a shoulder opening to form the end of the cylinder,
a front inlet and a top inlet communicating with the housing cylinder adapted to receive hydraulic connections,
a back wall connected to the wings and rear of the housing,
a closure plate for the back wall of the housing,
the back wall of the housing having a recess adapted for seating of a spring,
a piston comprising
a shaft with a top surface,
a seal disposed on the outer surface of the shaft, and
a cylinder formed in the shaft of the piston adapted to receive a spring,
the piston having arms extending rearward from the cylinder portion of the piston and spaced to allow passage of a spring disposed in the shaft past the arms of the piston,
apertures disposed in the arms for mounting of piston pins,
a return spring disposed in the spring guide shaft within the piston,
an output plate disposed in the housing,
wings extending from the top of the output plate and extending to the height of the arms of the piston,
elongated slots formed in the wings of the output plate in registration with the apertures in the arms of the piston,
piston pins extending through the apertures in the arms of the piston and through the elongated slots of the wings of the output plate,
a circular opening for an output drive gear formed in the output plate, and
an opening in the output plate for mounting a pawl,
an access opening in the drive plate for securing an output drive in the circular opening of the output drive gear,
an output drive in the aperture of the circular opening of the output plate,
a ratchet gear formed on the circumference of the output drive,
a pawl mounted in the opening for the pawl in the output plate,
a cover for the ratchet gear adapted to hold the output drive in the output plate,
a brake assembly for the ratchet gear comprising
an O ring in the cover of the ratchet gear,
and screw means threadably connected to the cover of the ratchet gear and extending into threaded passages in the output drive to enable tightening of the cover against the O ring and the lip of the side arms of the housing, and
hydraulic inlets in the cylinder of the housing to allow pressurized hydraulic fluid into the cylinder,
the hydraulic fluid to act upon the end of the piston to force the piston towards the rear of the housing against the action of the return spring, the rearward movement of the piston will then cause the piston pins to pivot the output plate connected to the piston, with the elongated slots in the output plate allowing the piston to move rearward along the axis of the piston and cause the output plate to rotate as the piston moves rearward until the end of the output plate coacts with the ramp of the piston to or can no longer overcome the force of the spring, the output plate connected to the output drive by means of the ratchet gear and pawl disposed in the output plate, and rotated with the rearward movement of the output plate, and upon relaxing of the hydraulic fluid will allow the spring to act against the rear wall of the housing and the front end of the spring guide shaft in the piston to urge the piston forward,
braking apparatus to control movement of the output drive relative to the output plate comprising:
cover means for the output drive,
an aperture formed in the output plate for receiving the output drive,
a lip in the aperture of the output plate;
O ring means disposed on the cover of the output drive;
threaded passage means in the cover of the output drive and
in the output drive; and
threaded means connecting the threaded passages in the output drive and the cover of the output drive to force the cover of the output drive to squeeze the O ring against the lip of the aperture of the output plate.

3. A hydraulic torque wrench comprising:
a housing,
an aperture in the housing for mounting an output plate,
a back wall mounted on the housing,
a cylinder formed in the housing having a front end, a cylindrical wall, and a rear opening,
a piston disposed in the cylinder,
a spring guide shaft in the piston,
a return spring disposed in the spring guide shaft of the piston and coacting with the housing,
an output plate pivotally connected to the piston,
an output drive connected to the output plate,
inlet means in the cylinder to allow intake of pressurized fluid to move the piston and pivot the output plate against the force of the return spring,
wherein the rear wall of the housing is connected to the rear of the housing by means of threaded fasteners.

4. A hydraulic torque wrench comprising:
a housing,
an aperture in the housing for mounting an output plate,
a back wall mounted on the housing,
a cylinder formed in the housing having a front end, a cylindrical wall, and a rear opening,
a piston disposed in the cylinder,
a spring guide shaft in the piston,
a return spring disposed in the spring guide shaft of the piston and coacting with the housing,
an output plate rotatably connected to the piston,
an output drive connected to the output plate,
inlet means in the cylinder to allow intake of pressurized fluid to move the piston and rotate the output plate against the force of the return spring,
wherein the rear wall of the housing is connected to the rear of the housing by means of threaded fasteners.

5. The hydraulic torque wrench of claim 4 wherein
the drive plate includes a contacting surface contoured for rolling contact,
the piston includes a cutout portion forming a contact surface for coaction with the contacting surface of the drive plate to allow for rolling contact of the drive plate with the piston as the piston moves along its path of travel.

6. The hydraulic torque wrench of claim 4 wherein
the piston further comprises slot means formed on the external surface of the piston,
stop means extending from the housing into the slot means formed in the piston,
the stop means coacting with the ends of the slot means to form a stop against extension of the piston in its predetermined limit of travel.

7. The hydraulic torque wrench of claim 4 wherein
the piston includes a shoulder,
the housing includes a shoulder at the ends of the cylinder,
the shoulder on the piston intended to coact with the shoulder at the end of the cylinder.
